(19) United States
(12) Patent Application Publication
(10) Pub. No.: US 2005/0265020 A1
(43) Pub. Date: Dec. 1, 2005

(54) Backlight assembly with simplified structure and display device provided with the same

(76) Inventor: Yong-Il Kim, Suwon-si (KR)

Correspondence Address: CANTOR COLBURN, LLP, 55 GRIFFIN ROAD SOUTH, BLOOMFIELD, CT, 06002, US

(21) Appl. No.: 11/122,400

(22) Filed: May 5, 2005

(30) Foreign Application Priority Data
May 7, 2004 (KR) 10-2004-0032182

(51) Int. Cl. F21S 4/00; F21V 7/00

(52) U.S. Cl. 362/225; 362/296; 362/216

(57) ABSTRACT

A backlight assembly with a simplified structure and a display device provided with the same includes lamps supplying light, lamp holders holding the lamps, a fixing member receiving the lamp holders, and a reflecting sheet. The lamp holders have exposed surfaces. The reflecting sheet includes an inclined portion covering a side of the fixing member. The reflecting sheet reflects light emitted by the lamps.

### CROSS-REFERENCE TO RELATED APPLICATIONS

The present application claims priority to Korean patent application No. 2004-0032182 filed in the Korean Intellectual Property Office on May 7, 2004, the entire contents of which are herein incorporated by reference in their entirety.

### BACKGROUND OF THE INVENTION

(a) Field of the Invention

The present invention relates to a backlight assembly with a simplified structure and a display device provided with the same, and more particularly, to a backlight assembly with a simplified structure and a display device provided with the same by removing a frame mold side and transforming a reflecting sheet.

(b) Description of Related Art

Recently, there has been an increased demand for small and light display devices with improved performance. The demand for such display devices has been fed by rapidly developing semiconductor technology.

Among display devices, a liquid crystal display (LCD) device has advantages in that it is small-sized, light-weight and consumes relatively low power. Therefore, the LCD device has been a popular choice as a substitute for existing cathode ray tube (CRT) display devices. As such, the LCD device is widely used for almost all information processing apparatuses that require display devices.

In a typical LCD device, a molecular alignment of liquid crystal is varied by applying a variable voltage to electrodes disposed on opposite sides of the liquid crystal. Variations in the molecular alignment of the liquid crystal cause a change of optical characteristics of a liquid crystal cell such as birefringence, optical rotary power, dichroism, and optical scattering and are converted into a visual change. Thus, in the LCD device, images are displayed by using an optical modulation of the liquid crystal cells.

Since an LCD device is a passive device, which cannot emit light, the LCD device is provided with a backlight unit, arranged below an LCD panel, which includes the liquid crystal, to illuminate the LCD panel. The backlight assembly includes a lamp, a light guide plate, a reflecting sheet, and a set of optical sheets. The lamp generates a relatively small amount of heat and emits a white light similar to a natural light. A cold cathode ray tube lamp is often used as the lamp.

Since the lamp is vulnerable to shock, lamp holders for holding the lamp are arranged at both ends of the lamp. As the LCD device becomes larger according to customer demand, a plurality of lamps are required in order to provide sufficient brightness to display images. Therefore, a frame mold side for holding a plurality of lamp holders has been employed. Addition of the frame mold side increases a total weight of the LCD device, requires additional assembling processes, and increases manufacturing cost. Additionally, a portion of light illuminating the LCD panel may be lost when employing the frame mold side since a reflection efficiency of the frame mold side is low. Low reflection efficiency may cause a dark area to occur at upper portions of both ends of a display screen of the LCD device where the frame mold side is arranged.

### SUMMARY OF THE INVENTION

The present invention is contrived to solve the above and other problems and the present invention provides a backlight assembly with a simplified structure, which has an alternative arrangement substituting for a frame mold side.

According to an aspect of the present invention, there is provided a backlight assembly including lamps supplying light, lamp holders holding the lamps, a fixing member receiving the lamps, and a reflecting sheet. The lamp holders have exposed surfaces. The reflecting sheet includes an inclined portion covering a side of the fixing member. The reflecting sheet reflects light emitted by the lamps.

A display device is provided which includes a panel unit displaying images; and a backlight assembly supplying light to the panel unit. The backlight assembly includes lamps supplying light, lamp holders holding the lamps, a fixing member receiving the lamps, and a reflecting sheet. The lamp holders have exposed surfaces. The reflecting sheet includes an inclined portion covering a side of the fixing member. The reflecting sheet reflects the light emitted by the lamps.

### BRIEF DESCRIPTION OF THE DRAWINGS

The above and other features and advantages of the present invention will become more apparent by describing in detail exemplary embodiments thereof with reference to the attached drawings in which:

FIG. 1 is an exploded perspective view of a backlight assembly according to an exemplary embodiment of the present invention;

FIG. 2 is a partial perspective view of the backlight assembly of FIG. 1 showing an alternate perspective;

FIG. 3 is a partial cross-sectional view taken along line A-A of FIG. 2;

FIG. 4 is a perspective view of a reflecting sheet enclosed in a backlight assembly according to an exemplary embodiment of the present invention;

FIG. 5 is an exploded perspective view of a reflecting sheet enclosed in a backlight assembly according to another exemplary embodiment of the present invention; and

FIG. 6 is an exploded perspective view of a reflecting sheet enclosed in a backlight assembly according to yet another exemplary embodiment of the present invention.

FIG. 7 is an exploded perspective view of a display device according to an exemplary embodiment of the present invention.

### DETAILED DESCRIPTION OF THE INVENTION

Exemplary embodiments of the present invention will be described with reference to the attached drawings. However, the present invention can be embodied in various modifications and thus is not limited to the embodiments described below.

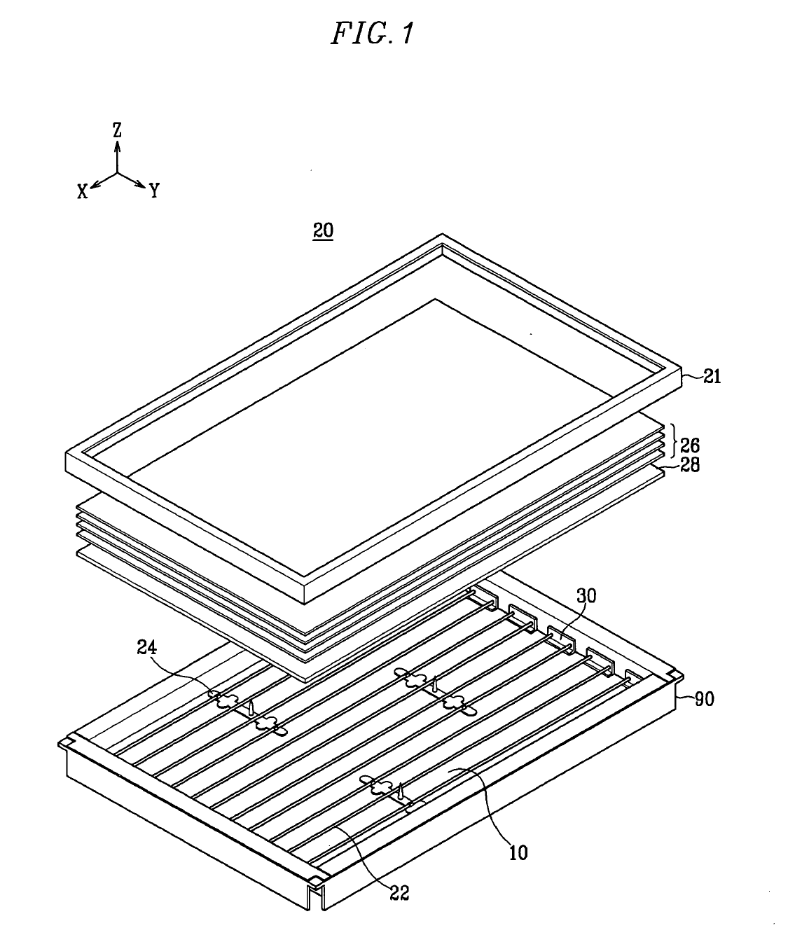

FIG. 1 is an exploded perspective view of a backlight assembly 20 according to an exemplary embodiment of the present invention. In this exemplary embodiment, a frame mold side is removed from the backlight assembly 20.

The backlight assembly 20 includes a lamp 22 supplying light and a lamp holder 30, which fixes the lamp 22. Additionally, the backlight assembly 20 includes a reflecting sheet 10, a diffusing plate 28 and optical sheets 26 in order to improve brightness of light emitted by the lamp 22. The backlight assembly 20 is fixed by a mold frame 21 and a fixing member 90. In an exemplary embodiment, the fixing member 90 receives a plurality of lamps 22. The fixing member 90 is a chassis made of, for example, a metal or a resin. The lamps 22 extend in a first direction along X-axis of the backlight assembly 20, as shown in FIG. 1. The lamps 22 may be bent at a middle portion of the lamps 22 to form a U-shaped structure. Supporting members 24 are provided under the lamps 22 in order to support the lamps 22. Additionally, the lamp holder 30 is provided at first and second ends of each of the lamps 22 in order to support the lamps 22.

Although not shown in FIG. 1, an inverter, which is a printed circuit board (PCB) for supplying power, is arranged on the rear surface of the fixing member 90. The inverter converts external power into a certain level voltage to apply as power to the lamps 22.

A structure of the backlight assembly 20 as shown in FIG. 1 is merely illustrative, and the present invention is not limited thereto. Therefore, it is possible to apply the present invention to other backlight assemblies having different structures.

Light emitted by the lamps 22 is directed toward the diffusing plate 28. Additionally, a portion of the light emitted by the lamps 22 is directed toward the reflecting sheet 10, which reflects the light toward the diffusing plate 28. Light reaching the diffusing plate 28 is diffused to almost all directions, thereby improving a uniformity of the light. Brightness of the light is also improved by passing through the optical sheets 26. Since the optical sheets 26 may comprise a protecting sheet, prism sheets and a diffusing sheet, it is possible to concentrate an intensity of light and then improve the brightness of the light.

According to an exemplary embodiment of the present invention, the reflecting sheet 10 is made in a form and may be folded and received in the fixing member 90. Additionally, sides of an upper surface of the fixing member 90 are covered with the reflecting sheet 10. Although the lamp holders 30 are conventionally covered with the frame mold side, the present invention only uses the reflecting sheet 10 without using frame mold sides to cover the lamp holders 30. The lamp holders 30 may be disposed at the fixing member 90 in order to hold the lamps 22 proximate to the reflecting sheet 10 and the fixing member 90. In an exemplary embodiment, the lamp holders 30 are disposed in pairs and exposed surfaces of each pair of the lamp holders face each other.

Accordingly, a loss of light due to the frame mold side may be reduced. In addition, since the frame mold side is not used, the number of parts of the backlight assembly 20 is reduced, thereby achieving a simple structure and lower manufacturing cost of the backlight assembly 20. Furthermore, since the reflecting sheet 10 may be made of foamy PET(polyethlene terephthalate), it is possible to emit light having a brightness and uniformity which is substantially improved as compared to a conventional backlight assembly. A structure of the backlight assembly 20 according to an exemplary embodiment of the present invention will be explained in detail below.

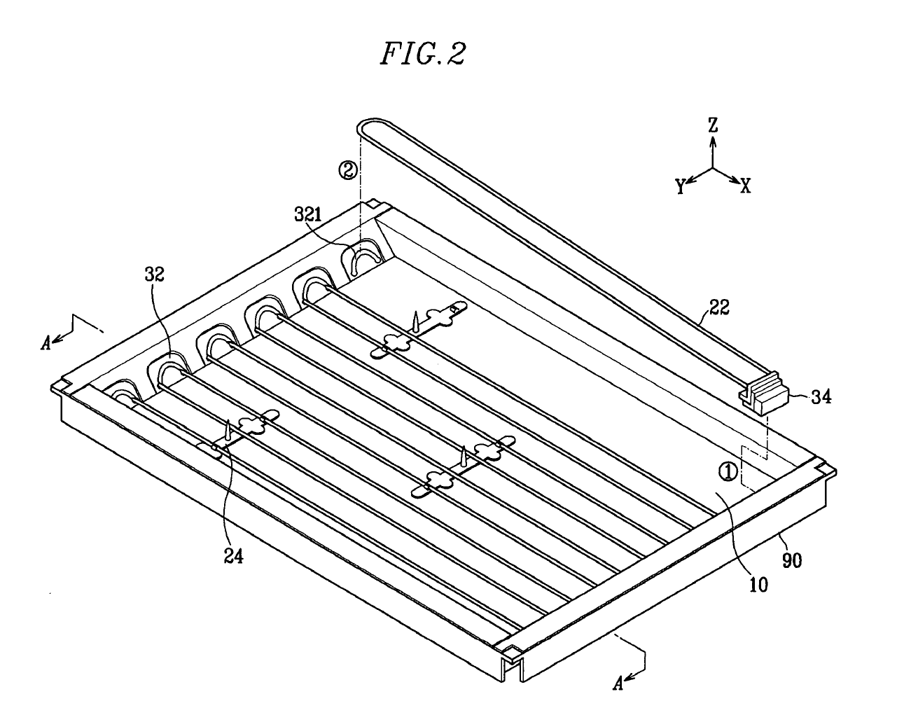

FIG. 2 shows a fixing member 90 covered with a reflecting sheet 10. The mold frame 21, the optical sheets 26 and the diffusing plate 28 shown in FIG. 1 are omitted in FIG. 2 in order to explain a structure of the reflecting sheet 10 in detail. For convenience of explanation, the fixing member 90 in FIG. 1 is rotated by 90° clockwise as to Z-axis in FIG. 2.

As shown in FIG. 2, lamp holders 30 include first lamp holders 32 and second lamp holders 34. Each of the first lamp holders 32 holds a bent portion of each of the lamps 22 at the middle portion of the lamps 22. The first lamp holders 32 are disposed at a first side of the fixing member 90. In addition, each of the second lamp holders 34 holds the first and second ends of each of the lamps 22. The second lamp holders 34 are disposed at a second side of the fixing member 90, which is opposite to the first side of the fixing member 90. Exposed surfaces of the first lamp holders 32 are inclined.

As stated above, the first lamp holders 32 each hold the bent portion of corresponding lamps 22. Since each of the lamps 22 is bent at the middle portion of the lamps 22, it is possible to significantly reduce a total number of lamps 22 and an assembling process may be simplified. Although the lamps 22 are shown as having the U-shaped structure in FIG. 2, such a structure is merely an exemplary embodiment of the lamps 22 and the present invention is not limited thereto.

The reflecting sheet 10 covers a side of the fixing member 90. Additionally, the reflecting sheet 10 is sloped at portions of the reflecting sheet 10 which correspond to the first and second sides of the fixing member 90. The reflecting sheet 10 is disposed between each of the first lamp holders 32, thereby reflecting light emitted by the lamps 22 in the Z-axis direction and reducing loss of light.

A combining direction of the first lamp holders 32 relative to the lamps 22 is different from a combining direction of the second lamp holders 34 relative to the lamps 22. For example, the bent portion of one of the lamps 22 is combined with a corresponding one of the first lamp holders 32 by exerting a force on the bent portion in the Z-axis direction. In other words, the bent portion of one of the lamps 22 is detachable from one of the first lamp holders 32 in a direction substantially perpendicular to a longitudinal direction of the lamps 22. To the contrary, the first and second ends of one of the lamps 22 are combined with the second lamp holders 34 in X-axis direction, as shown in FIG. 2. Since the first lamp holders 32 include an inclined portion covering the first side of the fixing member 90, the lamps 22 are detachable from the first lamp holder 32 in an upper direction, or the Z-axis direction. A combining process of the lamps 22 will be explained below.

First, a lamp 22 combined with a second lamp holder 34 is prepared. Second, the second lamp holder 34 coupled to the lamp 22 is fitted into an opening (not shown) on the second side of the fixing member 90. Finally, the bent portion of the lamp 22 is fitted into a lamp holding groove 321 formed on an upper surface of a first lamp holder 32 disposed at the first side of the fixing member 90. In this manner, the lamp 22 is received in the fixing member 90.

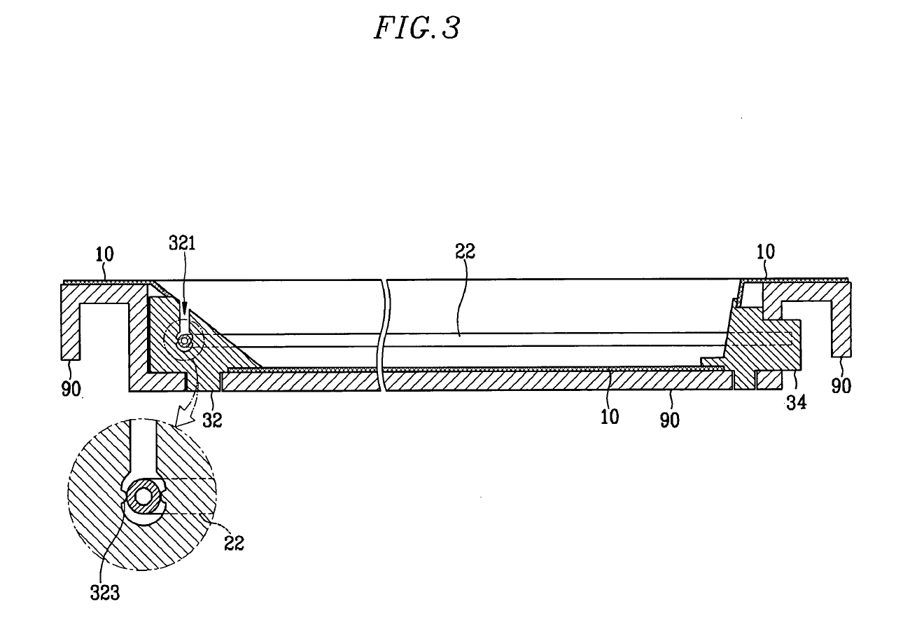

FIG. 3 is a partial cross sectional view taken along line A-A of FIG. 2. Referring to FIG. 3, an internal structure of the first lamp holder 32 will be described in detail.

As shown in FIG. 3, the first lamp holder 32 and the second lamp holder 34 are firmly fixed with the fixing member 90 and the reflecting sheet 10. Both the first lamp holder 32 and the second lamp holder 34 have an inclined portion and press a portion of the reflecting sheet 10 which is disposed at a bottom surface of the fixing member 90. Additionally, a portion of the second lamp holder 34 presses on an inclined portion of the reflecting sheet. Thus, both the first lamp holder 32 and the second lamp holder 34 firmly fix the reflecting sheet 10 to the fixing member 90.

The lamp 22 is firmly combined with the first lamp holder 32 and the second lamp holder 34, thereby protecting the lamp 22 from being broken. As shown in an enlarged circle of FIG. 3, a protrusion 323 is disposed at a portion of the lamp holding groove 321 in order to firmly fix the lamp 22. In an exemplary-embodiment as shown in FIG. 3, two protrusions are disposed at a portion of the lamp holding groove 321 to press on opposite sides of the lamp 22 to fix the lamp 22. Since a temperature of the bent portion of the lamp 22 is low, a great amount of Hg is collected at the bent portion making the bent portion increasingly susceptible to being broken. However, since the protrusion 323 is formed along the lamp holding groove 321, the lamp 22 is firmly fixed and Hg contained therein cannot be leaked.

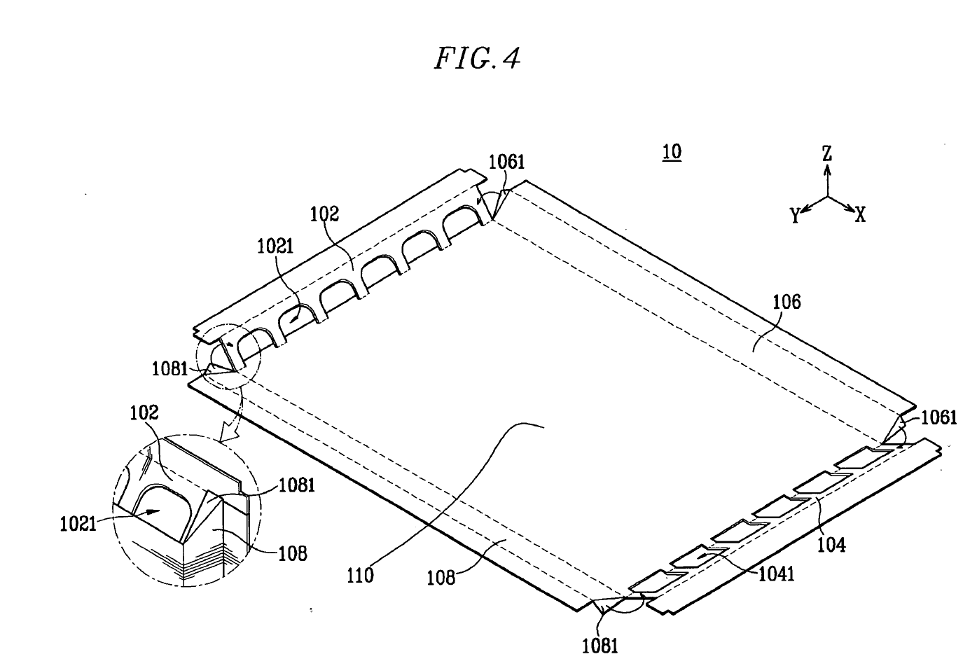

FIG. 4 shows the reflecting sheet 10, which is provided in the backlight assembly 20 in FIG. 1. The reflecting sheet shown in FIG. 4 is merely an example of the reflecting sheet 10 provided in the backlight assembly 20 according to an exemplary embodiment of the present invention and the present invention is not limited thereto. In other words, it is possible to modify the reflecting sheet 10 into other forms.

The reflecting sheet 10 for covering the fixing member 90 can be separated from the backlight assembly 20. The reflecting sheet 10 is folded along dotted lines of FIG. 4 and attached on the fixing member 90.

As shown in FIG. 4, first side openings 1021 and second side openings 1041 are formed at a first side portion 102 and a second side portion 104 of the reflecting sheet 10, respectively. The first and second side portions 102 and 104 face each other in the X-axis direction. The first and second lamp holders 32 and 34 are fitted into the first and second side openings 1021 and 1041, respectively. Furthermore, the first and second lamp holders 32 and 34 are fitted into the fixing member 90 through the first and second side openings 1021 and 1041 of the reflecting sheet 10.

The reflecting sheet 10 includes a bottom portion 110 and the first and second side portions 102 and 104, a third side portion 106, and a fourth side portion 108. In addition, other portions may be included in the reflecting sheet 10 if necessary. The bottom portion 110 covers a bottom surface of the fixing member 90. In addition, the first to fourth side portions 102, 104, 106 and 108 are separately formed on each edge of the bottom portion 110 and cover corresponding sides of the fixing member 90.

The ends of adjacent side portions among the first to fourth side portions 102, 104, 106 and 108 are overlapped with each other and attached to each other. As indicated by an arrow, third-side ends 1061 of the third side portion 106 and fourth-side ends 1081 of the fourth side portion 108 are overlapped with and attached to other adjacent side portions including the first and second side portions 102 and 104. The third-side ends 1061 and the fourth-side ends 1081 may be attached to rear surfaces of the first and second side portions 102 and 104 by a double sided tape, a stapler, or the like. On the contrary, the third-side ends 1061 and the fourth-side ends 1081 may be attached to front surfaces of the first and second side portions 102 and 104. For example, the fourth-side ends 1081 of the fourth side portion 108 may be attached to the rear surface of the first side portion 102, as shown in an enlarged circle of FIG. 4. Accordingly, it is possible to prevent light from leaking through corners of the reflecting sheet 10.

The reflecting sheet 10 may be made of foamy PET, thereby improving reflection efficiency. Since the foamy PET is difficult to manufacture, it is preferable that the corners are attached using the above-described method.

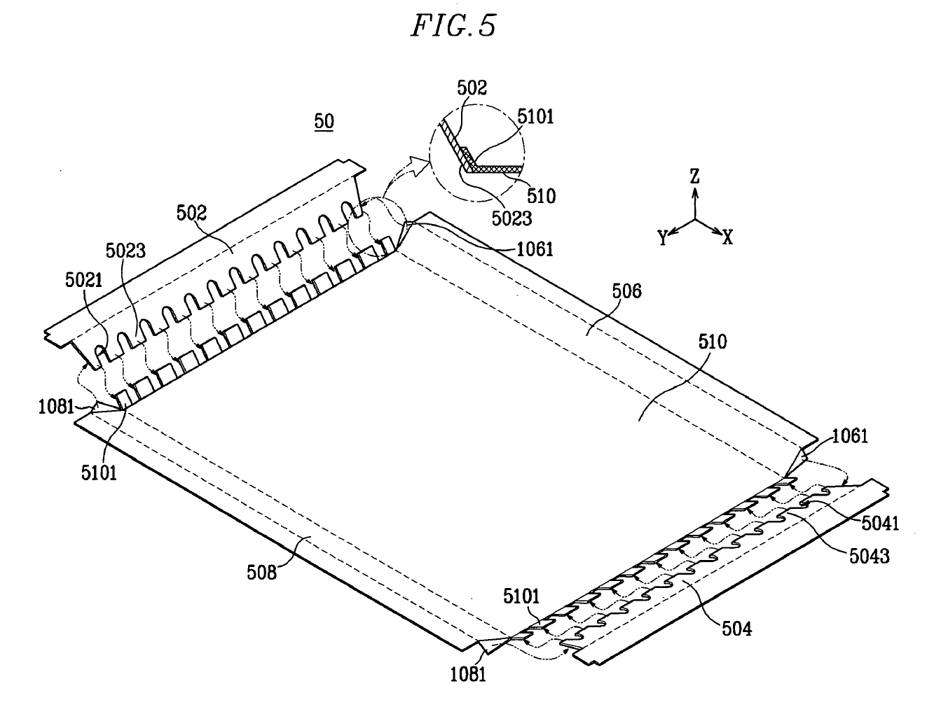

FIG. 5 shows another exemplary embodiment of a reflecting sheet 50 which is provided in the backlight assembly 20 according to an exemplary embodiment of the present invention. The reflecting sheet 50 is not an integrated type but a separation type. A separation type reflecting sheet may decrease a complexity of manufacture since the separation type reflecting sheet may be manufactured as separate parts that may be assembled.

The reflecting sheet 50 shown in FIG. 5 is merely an example of the separation type reflecting sheet and the present invention is not limited thereto. Therefore, it is possible to modify the reflecting sheet 50 into other forms.

The reflecting sheet 50 includes a bottom portion 510 and first to fourth side portions 502, 504, 506, and 508. The bottom portion 510 covers a bottom surface of the fixing member 90 (see FIG. 1). The first side portion 502 is disposed to correspond to the bent portion of each of the lamps 22. In other words, the first side portion 502 is disposed proximate to a first edge of the bottom portion 510 and extends perpendicular to a longitudinal length of the lamps 22. The second side portion 504 is disposed proximate to a second edge of the bottom portion 510 and faces the first side portion 502. The first and second edges of the bottom portion 510 are opposite each other with respect to the bottom portion 510. The third side portion 506 and the fourth side portion 508 face each other and are disposed at opposite edges of the bottom portion which are extended substantially perpendicular to the first and second side portions 502 and 504.

At least one of the first side portion 502 and the second side portion 504 is separately attached to the bottom portion 510. The adhesives, for example, double-sided tapes, staples, etc. can be used as an attaching means. As shown in an enlarged circle of FIG. 5, projections 5023 and 5043 formed at a lower portion of both the first and second side portions 502 and 504 are attached to exterior surfaces of connecting portions 5101 formed along the first and second edges of the bottom portion 510, which correspond to the first and second side portions 502 and 504.

The lamps 22 are fitted through openings 5021 and 5041 formed in the first and second side portions 502 and 504, respectively. The lamp holders 30 are attached to the fixing member 90 through the openings 5021 and 5041 in order to fix the lamps 22. Therefore, at least one of the first side portion 502 and second side portion 504 comes in contact with the lamp holders 30, thereby improving the reflecting efficiency of light.

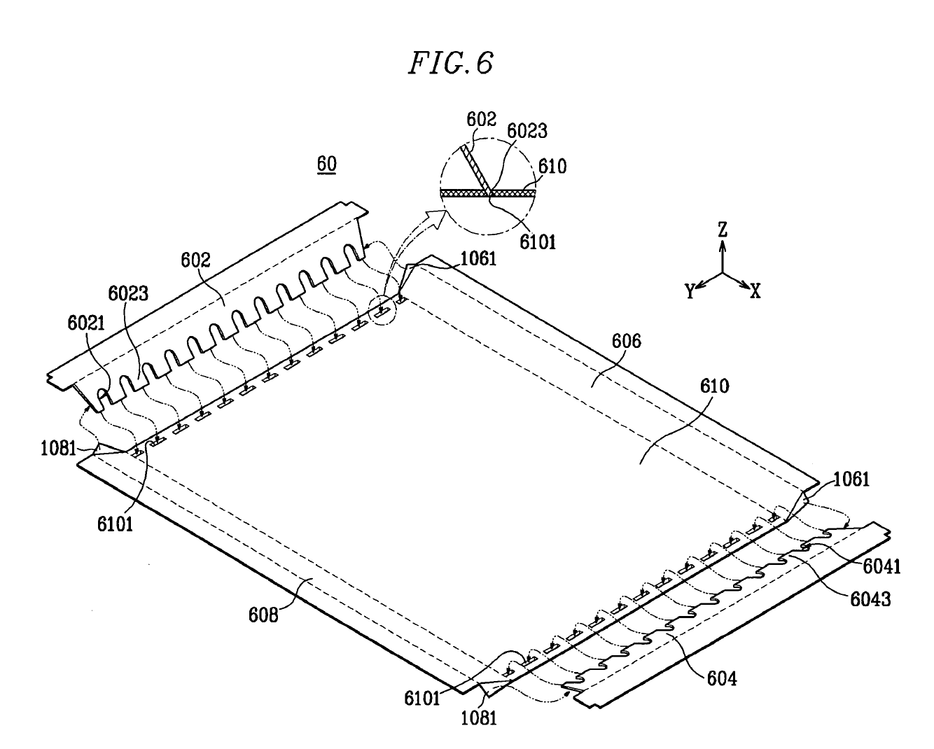

FIG. 6 shows another exemplary embodiment of a reflecting sheet 60 which is provided in the backlight assembly 20 according to another exemplary embodiment of the present invention. The reflecting sheet 60 shown in FIG. 6 is of the separation type.

The reflecting sheet 60 shown in FIG. 6 is merely an example of a separation type reflecting sheet and the present invention is not limited thereto. Therefore, it is possible to modify the reflecting sheet 60 into other forms.

The reflecting sheet 60 includes a bottom portion 610 and first to fourth side portions 602, 604, 606, and 608. The first to fourth side portions 602, 604, 606, and 608 are disposed substantially similar to the arrangement of FIG. 5. The bottom portion 610 covers the bottom surface of the fixing member 90. The first side portion 602 is disposed to correspond to the bent portion of each of the lamps 22. The second portion 604 faces the first side portion 602. The third side portion 606 and the fourth side portion 608 face each other.

At least one of the first side portion 602 and the second side portion 604 is separately fitted to the bottom portion 610. Since grooves 6101 are formed on the bottom portion 610 to correspond to the first and second side portions 602 and 604, the first side portion 602 and the second side portion 604 can be fitted into the grooves 6101 to fix the first and second side portions 602 and 604 to the bottom portion 610. Therefore, attaching means such as adhesives are not necessary to attach the first and second side portions 602 and 604 to the bottom portion 610 of the reflecting sheet 60. As shown in an enlarged circle of FIG. 6, projections 6023 and 6043 formed at a lower portion of both the first and second side portions 602 and 604 are fitted into the grooves 6101 formed on the bottom portion 610.

The lamps are fitted through openings 6021 and 6041 formed in the first side portion 602 and the second side portion 604, respectively. The lamp holders 30 are attached to the fixing member 90 through the openings 6021 and 6041 in order to fix the lamps 22 (also referring to FIG. 1). Therefore, at least one of the first side portion 602 and second side portion 604 comes in contact with the lamp holders 30, thereby improving the reflecting efficiency of light.

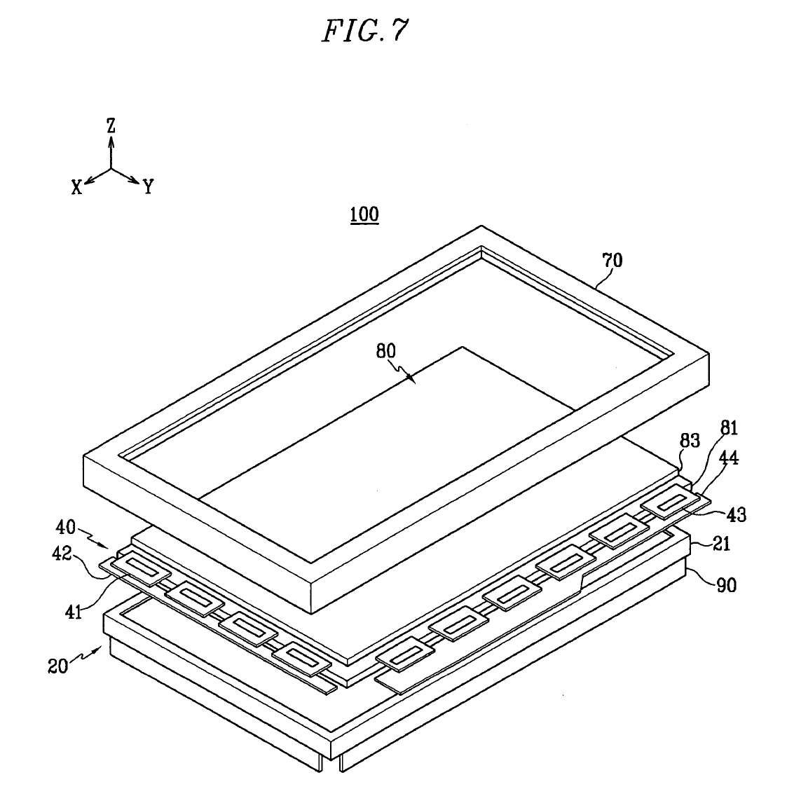

FIG. 7 shows a display device 100 according to an exemplary embodiment of the present invention. A structure of the display device 100 as shown in FIG. 7 is merely an example of the present invention and the present invention is not limited thereto. Therefore, it is possible to modify the display device 100 into other forms.

In addition, although an LCD panel 80 is shown as a panel unit in FIG. 7, it is merely an exemplary embodiment of a panel unit and the present invention is not limited thereto. Therefore, it is possible to use other panel units.

As shown in FIG. 7, the display device 100 comprises an LCD panel 80 which displays images and the backlight assembly 20 for supplying the light to the LCD panel 80. An LCD panel assembly 40 comprises the LCD panel 80, gate and data driver integrated circuit packages 41 and 43, and gate and data printed circuit boards (PCBs) 42 and 44. The gate and data driver integrated circuit packages 41 and 43 are electrically connected to gate lines and data lines, respectively, which are formed on the LCD panel 80. The gate and data driver integrated circuit packages 41 and 43 may be, for example, chip on film, tape carrier package and so on.

The LCD panel 80 comprises a TFT (thin film transistor) panel 81 including a plurality of thin film transistors, a color filter panel 83 disposed over the TFT panel 81, and liquid crystal (not shown) injected between two substrates.

The TFT panel 81 is a transparent glass panel in which the plurality of thin film transistors are formed in a matrix. Source terminals formed on the TFT panel 81 are electrically connected to the data lines, and gate terminals formed on the TFT panel 81 are electrically connected to gate lines. In addition, pixel electrodes made of transparent ITO (indium tin oxide) as conductive materials are formed at drain terminals of the thin film transistors.

The data lines and the gate lines of the LCD panel 80 are electrically connected to the data and gate driver integrated circuit packages 43 and 41, respectively. If data electrical signals from the data PCB 44 are input to the source terminals and gate electrical signals from the gate PCB 42 are input to the gate terminals of the TFTs, the TFTs turn-on or turn-off in accordance with the data and gate electrical signals. A control board (not shown) electrically connected to the data PCB 44 receives driving signals from outside and applies the driving signals to the data lines and the gate lines of the LCD panel 80.

The color filter panel 83 is arranged proximate to the TFT panel 81 such that the color filter panel 83 and the TFT panel 81 face each other. The color filter panel 83 is a panel where RGB pixels, which may represent various colors as light passes through the RGB pixels, are formed on the color filter panel 83. A common electrode made of ITO is formed on an entire surface of the color filter panel 83. If a driving voltage is applied to gate terminals and source terminals of a TFT in order to turn-on the TFT, an electric field is formed between the pixel electrode and the common electrode of the color filter panel 83. An arrangement angle of the liquid crystal injected between the TFT panel 81 and the color filter panel 83 is varied due to the electric field such that light permeability is varied in accordance with a variation of the arrangement angle and thus a desired pixel color is obtained.

The gate PCB 42 transmits gate driving signals to the LCD panel 80 through the gate driver integrated circuit packages 41 and the data PCB 44 transmits a data driving signals to the LCD panel 80 through the data driver integrated circuit packages 43.

The backlight assembly 20 is disposed below the LCD panel assembly 40 in order to uniformly supply light to the LCD panel 80. The LCD panel assembly 40 is received on the backlight assembly 20 by a top chassis 70. The backlight assembly 20 includes a reflecting sheet without a frame mold side, thereby supplying light having a high brightness and good uniformity.

According to the present invention, since the frame mold side is not necessary, a structure of the backlight assembly is simplified, and a manufacturing cost is reduced.

A reflecting sheet has an inclined portion, thereby improving a reflecting efficiency of light. The inclined portion of the reflecting sheet has one or more openings, thereby allowing insertion of lamp holders to engage a fixing member through the one or more openings. Since a bent portion of each lamp is fixed by the lamp holder, it is possible to stably support each lamp. Furthermore, since a lamp holding groove is formed in the lamp holder, the lamp can be firmly fixed.

Since the lamp can be detachable from the lamp holder in an upper direction, it is much easier to combine and separate the lamp with the fixing member. Since the reflecting sheet is made of foamy PET, reflecting efficiency of the reflecting sheet is very good. The reflecting sheet may be made as a separation type reflecting sheet, thereby enabling reduced complexity in manufacturing a backlight assembly.

While the present invention has been particularly shown and described with reference to exemplary embodiments thereof, it will be understood by those skilled in the art that various changes in form and details may be made therein without departing from the spirit and scope of the invention as defined by the appended claims.

1. A backlight assembly comprising:
lamps supplying light;
lamp holders holding the lamps and having exposed surfaces;
a fixing member receiving the lamp holders; and
a reflecting sheet that includes an inclined portion covering a side of the fixing member and reflecting light emitted by the lamps.

2. The backlight assembly of claim 1, wherein the lamp holders are disposed in pairs and the exposed surfaces of each pair of the lamp holders face each other.

3. The backlight assembly of claim 1, wherein the inclined portion of the reflecting sheet has at least one opening.

4. The backlight assembly of claim 3, wherein the lamp holders are each fitted into the fixing member through each of the at least one opening of the reflecting sheet.

5. The backlight assembly of claim 4, wherein the exposed surfaces of the lamp holders each project out of each of the at least one opening.

6. The backlight assembly of claim 1, wherein the lamp holders comprise first lamp holders and second lamp holders for holding the lamps, and a combining direction for combining the first lamp holders to the lamps is different from a combining direction for combining the second lamp holders to the lamps.

7. The backlight assembly of claim 6, wherein the reflecting sheet covers a side of the fixing member to which the first lamp holders are fitted, and exposed surfaces of the first lamp holders are inclined.

8. The backlight assembly of claim 7, wherein the lamps comprise bent portions fixed by the first lamp holders.

9. The backlight assembly of claim 8, wherein the lamps are detachable from the first lamp holders in a direction substantially perpendicular to a longitudinal direction of the lamps.

10. The backlight assembly of claim 7, wherein each of the first lamp holders has a lamp holding groove, and a protrusion is formed at a portion of the lamp holding groove of each of the first lamp holders in order to fix each of the lamps.

11. The backlight assembly of claim 7, wherein each of the first lamp holders has a lamp holding groove, and two protrusions are disposed at a portion of the lamp holding groove to press on opposite sides of each of the lamps to fix the lamps.

12. The backlight assembly of claim 1, wherein the reflecting sheet comprises:
a bottom portion covering a bottom surface of the fixing member; and
side portions that extend from edges of the bottom portion to cover sides of the fixing member, each of the side portions including the inclined portion, and
wherein adjacent side portions overlap each other and are attached to each other.

13. The backlight assembly of claim 1, wherein the reflecting sheet comprises:
a bottom portion covering a bottom surface of the fixing member;
a first side portion disposed proximate to a first edge of the bottom portion and extending perpendicular to a longitudinal direction of the lamps; and
a second side portion disposed proximate to a second edge of the bottom portion facing the first side portion, the second side portion extending substantially parallel to the first side portion, and
wherein at least one of the first side portion and the second side portion is attached to the bottom portion.

14. The backlight assembly of claim 13, wherein at least one of the first side portion and the second side portion contacts the lamp holders.

15. The backlight assembly of claim 1, wherein the reflecting sheet comprises:
a bottom portion covering a bottom surface of the fixing member, the bottom portion including grooves;
a first side disposed proximate to a first edge of the bottom portion and extending perpendicular to a longitudinal direction of the lamps; and
a second side portion disposed proximate to a second edge of the bottom portion facing the first side portion, the second side portion extending substantially parallel to the first side portion, and
wherein at least one of the first side portion and the second side portion has portions inserted into the grooves of the bottom portion.

16. The backlight assembly of claim 1, wherein the reflecting sheet includes a first side portion and a second side portion and at least one of the first side portion and the second side portion is in contact with the exposed surfaces of the lamp holders.

17. The backlight assembly of claim 1, wherein the reflecting sheet comprises foamy PET (polyethlene terephthalate).

18. The backlight assembly of claim 1, wherein the fixing member is made of a metal.

19. The backlight assembly of claim 1, wherein the fixing member is made of a resin.

20. A display device comprising:
a panel unit for displaying images; and
a backlight assembly supplying light to the panel unit, wherein the backlight assembly comprises:
lamps supplying light;
lamp holders holding the lamps and having exposed surfaces;
a fixing member receiving the lamp holders; and
a reflecting sheet that includes an inclined portion covering a side of the fixing member and reflecting light emitted by the lamps.

21. The display device of claim 20, wherein the lamp holders are disposed in pairs and the exposed surfaces of each pair of the lamp holders face each other.

22. The display device of claim 20, wherein the inclined portion of the reflecting sheet has at least one opening.

23. The display device of claim 22, wherein the lamp holders are each fitted into the fixing member through each of the at least one opening of the reflecting sheet.

24. The display device of claim 23, wherein the exposed surfaces of the lamp holders each project out of each of the at least one opening.

25. The display device of claim 20, wherein the lamp holders comprise first lamp holders and second lamp holders for holding the lamps, and a combining direction for combining the first lamp holders to the lamps is different from a combining direction for combining the second lamp holders to the lamps.

26. The display device of claim 25, wherein the reflecting sheet covers a side of the fixing member to which the first lamp holders are fitted, and exposed surfaces of the first lamp holders are inclined.

27. The display device of claim 26, wherein the lamps comprise bent portions fixed by the first lamp holders.

28. The display device of claim 27, wherein the lamps are detachable from the first lamp holders in a direction substantially perpendicular to a longitudinal direction of the lamps.

29. The display device of claim 26, wherein each of the first lamp holders has a lamp holding groove, and a protrusion is formed at a portion of the lamp holding groove of each of the first lamp holders in order to fix each of the lamps.

30. The display device of claim 25, wherein supporting members are disposed at the fixing member between the first and second lamp holders to support the lamps.

31. The display device of claim 20, wherein the reflecting sheet comprises:
a bottom portion covering a bottom surface of the fixing member;
a first side portion disposed proximate to a first edge of the bottom portion and extending perpendicular to a longitudinal direction of the lamps; and
a second side portion disposed proximate to a second edge of the bottom portion facing the first side portion, the second side portion extending substantially parallel to the first side portion, and
wherein at least one of the first side portion and the second side portion is attached to the bottom portion.

32. The display device of claim 20, wherein the reflecting sheet comprises:
a bottom portion covering an bottom surface of the fixing member, the bottom portion including grooves;
a first side portion disposed proximate to a first edge of the bottom portion and extending perpendicular to a longitudinal direction of the lamps; and
a second side portion disposed proximate to a second edge of the bottom portion facing the first side portion, the second side portion extending substantially parallel to the first side portion, and
wherein at least one of the first side portion and second side portion has portions inserted into the grooves of the bottom portion.

33. The display device of claim 20, wherein the fixing member is made of a metal.

34. The display device of claim 20, wherein the fixing member is made of a resin.
